(19) United States
(12) Patent Application Publication
(10) Pub. No.: US 2007/0097283 A1
(43) Pub. Date: May 3, 2007

(54) Backlight control circuit with dual input circuits

(75) Inventors: Tong Zhou, Shenzhen (CN); Kun Le, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/590,371

(22) Filed: Oct. 30, 2006

(30) Foreign Application Priority Data
Oct. 28, 2005 (CN) 200510100805.4

(51) Int. Cl. G02F 1/136

(52) U.S. Cl. 349/46

(57) ABSTRACT

An exemplary backlight control circuit (200) includes two load circuits (210), a pulse width modulation integrated circuit (PWM IC) (250) having a current sampling pin (251), a first transistor (271), a first input circuit (230) and a second input circuit (240) including an input resistor. Each load circuit includes an output end (212, 222). The first input circuit includes a second transistor (234). The drain electrode of the first transistor is connected to the current sampling pin. The gate electrode of the first transistor is connected to the drain electrode of the second transistor and is connected to a power supply. The gate electrode of the second transistor is connected to one of the output ends of the load circuits via the diode. The other one of the output ends of the load circuits is connected to the current sampling pin via the input resistor.

### FIELD OF THE INVENTION

The present invention relates to a backlight control circuit typically used in a liquid crystal display (LCD).

### GENERAL BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions.

A typical LCD includes an LCD panel, a plurality of backlights for illuminating the LCD panel, an inverter circuit for driving the backlights, and a backlight control circuit. The baclight control circuit generally includes a pulse width modulation integrated circuit (PWM IC) for driving the inverter circuit, and a backlight protecting circuit for shutting down the PWM IC when any one of the backlights has an open circuit or a short circuit connecting to ground.

FIG. 3 is an abbreviated diagram of a typical backlight control circuit used in an LCD. The backlight control circuit 100 includes load circuits 110, a pulse width modulation integrated circuit (PWM IC) 150, and a backlight protection circuit (not labeled). The backlight protection circuit includes a first transistor 171, a current limiting resistor 172, and an input circuit 130.

Each load circuit 110 includes a backlight 111 and a backlight inspecting circuit 123 connected in series between a backlight power supply (not shown) and ground. The backlight inspecting circuit 123 includes an output end 112. The output end 112 provides a high voltage when the corresponding backlight 111 works. The output end 112 provides a low voltage when the corresponding backlight 111 has an open circuit or a short circuit connecting to ground.

The PWM IC 150 includes a current sampling pin 151. The PWM IC 150 stops working if the current sampling pin 151 has a low voltage.

The first transistor 171 includes a source electrode “S”, a drain electrode “D”, and a gate electrode “G”. The source electrode “S” is connected to ground. The drain electrode “D” is connected to the current sampling pin 151 of the PWM IC 150. The gate electrode “G” is connected to a power supply via the current limiting resistor 172. The power supply is provided by a power pin (not labeled) of the PWM IC 150.

The input circuit 130 includes four diodes 131, four resistors 132, four capacitors 135, a second transistor 1332, a third transistor 1333, a fourth transistor 1334, and a fifth transistor 1335. Each transistor 1332, 1333, 1334, 1335 includes a source electrode “S”, a drain electrode “D”, and a gate electrode “G”. The drain electrode “D” of the second transistor 1332 is connected to the gate electrode “G” of the first transistor 171. The drain electrode “D” of the third transistor 1333 is connected to the source electrode “S” of the second transistor 1332. The drain electrode “D” of the fourth transistor 1334 is connected to the source electrode “S” of the third transistor 1333. The drain electrode “D” of the fifth transistor 1335 is connected to the source electrode “S” of the fourth transistor 1334. The source electrode “S” of the fifth transistor 1335 is connected to ground. The gate electrodes “G” of the second, third, fourth, and fifth transistors 1332, 1333, 1334, 1335 are connected to the negative terminals of the four diodes 131, respectively. The positive terminals of the four diodes 131 are respectively connected to the output ends 112 of the backlight inspecting circuits 123. Each of the gate electrodes “G” of the second, third, fourth, and fifth transistors 1332, 1333, 1334, 1335 is connected to ground via the corresponding resistor 132, and is connected to ground via the corresponding capacitor 135.

The first transistor 171, the second transistor 1332, the third transistor 1333, the fourth transistor 1334 and the fifth transistor 1335 are negative-channel metal oxide semiconductor (NMOS) type transistors.

Operation of the backlight control circuit 100 is as follows. When all the backlights 111 work normally, each of the output ends 112 provides a high voltage to the gate electrode “G” of the corresponding one of the second, third, fourth, and fifth transistors 1332, 1333, 1334, 1335 via the corresponding diode 131. Then the second, third, fourth, and fifth transistors 1332, 1333, 1334, 1335 are switched to an activated state, and the gate electrode “G” of the first transistor 171 is connected to ground via the activated second, third, fourth, and fifth transistors 1332, 1333, 1334, 1335. Thus the first transistor 171 is turned off, and the current sampling pin 151 of the PWM IC 150 maintains an original working voltage.

When any one of the backlights 111 has an open circuit or has a short circuit connecting to ground, the corresponding output end 112 of the backlight inspecting circuit 123 provides a low voltage to the gate electrode “G” of the corresponding one of the second, third, fourth, and fifth transistors 1332, 1333, 1334, 1335 via the corresponding diode 131. Then the corresponding second, third, fourth, or fifth transistor 1332, 1333, 1334, 1335 is turned off, so that the gate electrode “G” of the first transistor 171 is charged to a high voltage via the current limiting resistor 172. Thus the first transistor 171 is switched to an activated state, and the current sampling pin 151 of the PWM IC 150 is connected to ground via the activated first transistor 171. Consequently, the current sampling pin 151 of the PWM IC 150 is charged to a low voltage, and the PWM IC 150 stops working.

The backlight control circuit 100 includes the five transistors 171, 1332, 1333, 1334, 1335 needed to carry out the function of protecting the backlights 111. Further, the number of transistors needed increases with the number of backlights 111 used in the LCD. Consequently, the cost of the backlight control circuit 100 is high, particularly in the case where the number of backlights 111 is large.

It is desired to provide a backlight control circuit that can be used in an LCD, which backlight control circuit overcomes the above-described deficiencies.

### SUMMARY

In a preferred embodiment, a backlight control circuit includes a first backlight inspecting circuit, a second backlight inspecting circuit, a PWM IC, a first transistor, a first input circuit, and a second input circuit having an input resistor. Each backlight inspecting circuit includes a backlight and a output end. The PWM IC includes a current sampling pin. The first transistor includes a source electrode connected to ground, a drain electrode connected to the current sampling pin of the PWM IC, and a gate electrode connected to a power supply. The first input circuit includes a diode, a resistor, a capacitor, and a second transistor. The second transistor includes a drain electrode connected to the gate electrode of the first transistor, a source electrode connected to ground, and a gate electrode connected to ground via the resistor and the capacitor respectively. The gate electrode of the second transistor is connected to the negative terminal of the diode. The positive terminal of the diode is connected to one of the output ends of the backlight inspecting circuits. The other one of the output ends of the backlight inspecting circuits is connected to the current sampling pin of the PWM IC via the input resistor.

Advantages and novel features of the above-described circuit will become more apparent from the following detailed description when taken in conjunction with the accompanying drawings.

### BRIEF DESCRIPTION OF THE DRAWINGS

FIG. 1 is an abbreviated diagram of a backlight control circuit according to a first embodiment of the present invention, the backlight control circuit being typically used in an LCD.

FIG. 2 is an abbreviated diagram of a backlight control circuit according to a second embodiment of the present invention, the backlight control circuit being typically used in an LCD.

FIG. 3 is an abbreviated diagram of a conventional backlight control circuit used in an LCD.

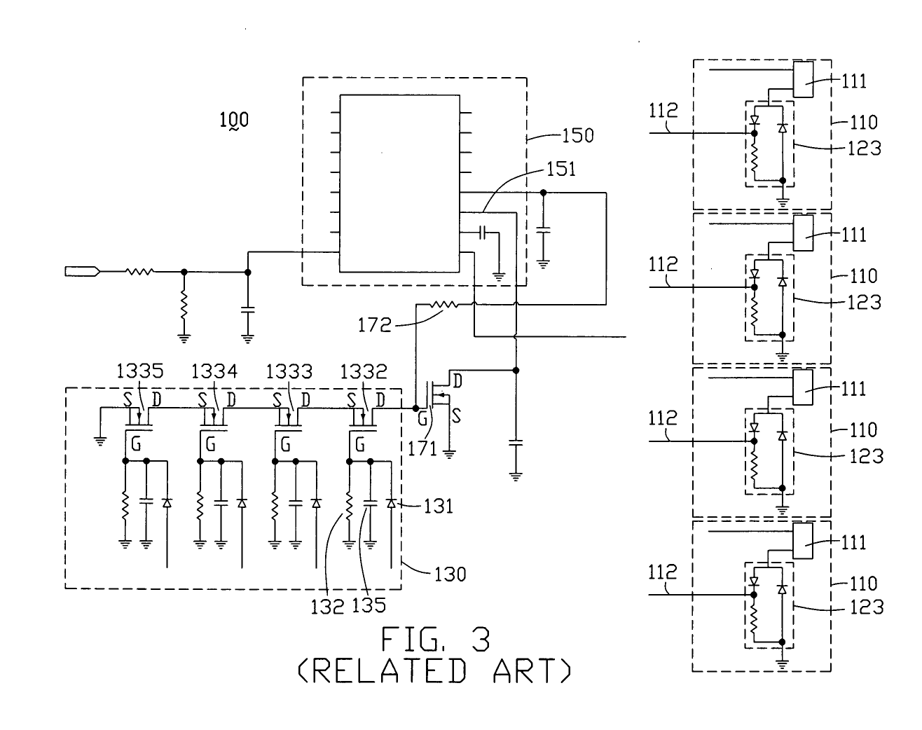

### DETAILED DESCRIPTION OF PREFERRED EMBODIMENTS

Reference will now be made to the drawings to describe the present invention in detail.

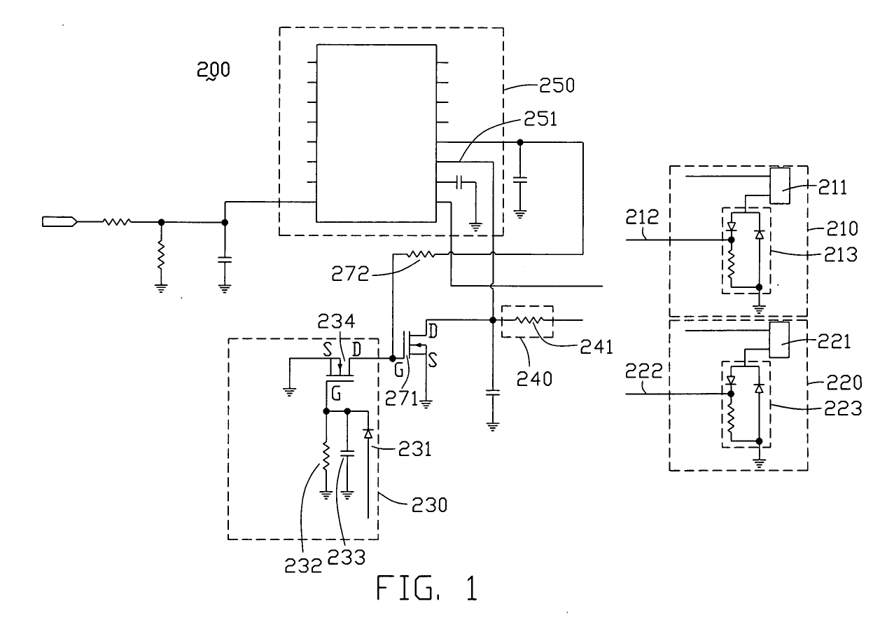

FIG. 1 is an abbreviated diagram of a backlight control circuit according to a first embodiment of the present invention, the backlight control circuit being typically used in an LCD. The backlight control circuit 200 includes two load circuits 210, 220, a PWM IC 250, and a backlight protection circuit (not labeled). The backlight protection circuit includes a first transistor 271, a first input circuit 230, and a second input circuit 240.

The load circuit 210 includes a backlight 211 and a backlight inspecting circuit 213 connected in series between a backlight power supply (not shown) and ground. The backlight inspecting circuit 213 includes an output end 212. The load circuit 220 includes a backlight 221 and a backlight inspecting circuit 223 connected in series between the backlight power supply (not shown) and ground. The backlight inspecting circuit 223 includes an output end 222. Each of the output ends 212, 222 provides a low voltage when the corresponding backlight 211 or backlight 221 has an open circuit or a short circuit connecting to ground.

The PWM IC 250 includes a current sampling pin 251. The PWM IC 250 stops working if the current sampling pin 251 has a low voltage.

The first transistor 271 includes a source electrode “S”, a drain electrode “D”, and a gate electrode “G”. The source electrode “S” of the first transistor 271 is connected to ground. The drain electrode “D” of the first transistor 271 is connected to the current sampling pin 251 of the PWM IC 250. The gate electrode “G” of the first transistor 271 is connected to a power supply via a current limiting resistor 272. The power supply is provided by a power pin (not labeled) of the PWM IC 250, and is typically a five volt direct current power supply.

The first input circuit 230 includes a second transistor 234, a diode 231, a resistor 232, and a capacitor 233. The second transistor 234 includes a source electrode “S”, a drain electrode “D”, and a gate electrode “G”. The drain electrode “D” of the second transistor 234 is connected to the gate electrode “G” of the first transistor 271. The source electrode “S” of the second transistor 234 is connected to ground. The gate electrode “G” of the second transistor 234 is connected to the negative terminal of the diode 231, and is connected to ground respectively via the resistor 232 and via the capacitor 233. The positive terminal of the diode 231 is connected to the output end 222 of the backlight inspecting circuit 223.

The second input circuit 240 includes an input resistor 241. The output end 212 of the backlight inspecting circuit 213 is connected to the current sampling pin 251 of the PWM IC 250 via the input resistor 241.

The diode 231 can for example be an SN4148 type diode. A resistance of the current limiting resistor 272 is preferably 100 KΩ. A resistance of the input resistor 241 is preferably 3.9 KΩ. Alternatively, the resistance of the input resistor 241 can be 1.0MΩ. The PWM IC 250 can for example be an OZ9910G type PWM IC. The first transistor 271 and the second transistor 234 can be negative-channel metal oxide semiconductor (NMOS) type transistors or negative-positive-negative (NPN) type transistors.

Generally, operation of the backlight control circuit 200 is as follows. When the backlight 211 of the load circuit 210 works, the output end 212 of the backlight inspecting circuit 213 provides a high voltage to the current sampling pin 251 of the PWC IC 250 via the input resistor 241. When the backlight 221 of the load circuit 220 works, the output end 222 of the backlight inspecting circuit 223 provides a high voltage to the gate electrode “G” of second transistor 234 via the diode 231. Then the second transistor 234 is switched to be in an activated state, and the gate electrode “G” of the first transistor 271 is connected to ground via the activated second transistor 234. Thus the first transistor 271 is turned off, the current sampling pin 251 of the PWM IC 250 maintains the high voltage, and the PWM IC 250 continues working.

When the backlight 221 has an open circuit or a short circuit connecting to ground, the output end 222 of the backlight inspecting circuit 223 provides a low voltage to the gate electrode “G” of the second transistor 234 via the diode 231. Then the second transistor 234 is turned off, so that the gate electrode “G” of the first transistor 271 is charged to a high voltage by the power supply. Thus the first transistor 271 is switched to be in an activated state, so that the current sampling pin 251 of the PWM IC 250 is connected to ground via the activated first transistor 271. Then the current sampling pin 251 of the PWM IC 250 is discharged to a low voltage, and the PWM IC 250 stops working.

When the backlight 211 has an open circuit or a short circuit connecting to ground, the output end 212 of the backlight inspecting circuit 213 directly provides a low voltage to the current sampling pin 251 of the PWM IC 250 via the input resistor 241. Thus, the PWM IC 250 stops working.

The backlight control circuit 200 needs only the two transistors 271, 234 to carry out the function of protecting the backlights 211, 221. Therefore, the backlight control circuit 200 has low cost.

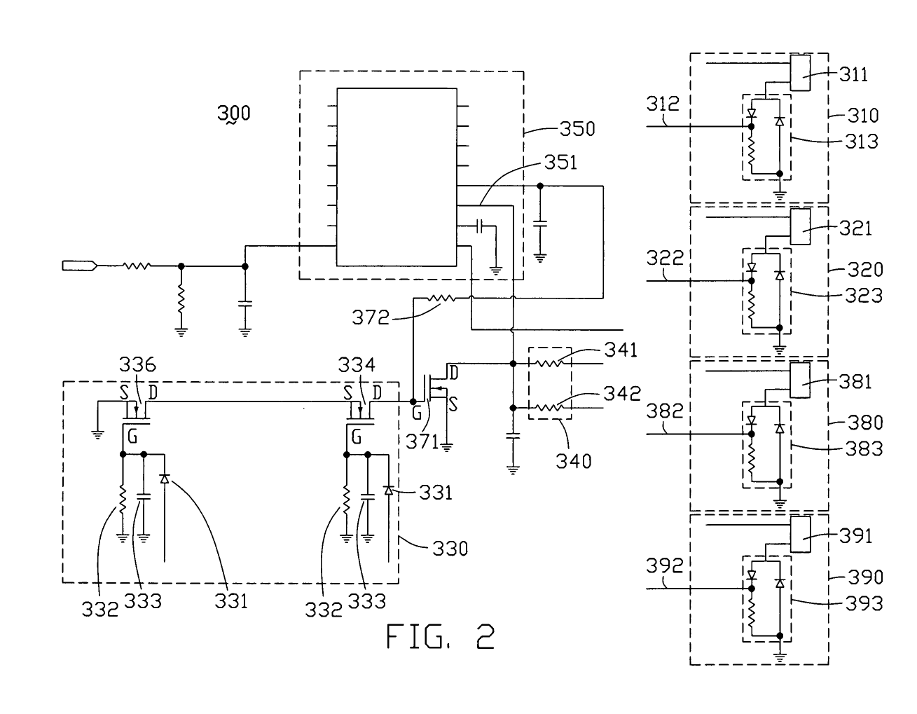

FIG. 2 is an abbreviated diagram of a backlight control circuit according to a second embodiment of the present invention, the backlight control circuit being typically used in an LCD. The backlight control circuit 300 includes load circuits 310, 320, 380, 390, a PWM IC 350, and a backlight protection circuit (not labeled). The backlight protection circuit includes a first transistor 371, a first input circuit 330, and a second input circuit 340.

The load circuit 310 includes a backlight 311 and a backlight inspecting circuit 313 connected in series between a backlight power supply (not shown) and ground. The load circuit 320 includes a backlight 321 and a backlight inspecting circuit 323 connected in series between the backlight power supply (not shown) and ground. The load circuit 380 includes a backlight 381 and a backlight inspecting circuit 383 connected in series between the backlight power supply (not shown) and ground. The load circuit 390 includes a backlight 391 and a backlight inspecting circuit 393 connected in series between the backlight power supply (not shown) and ground.

Each backlight inspecting circuit 313, 323, 383, 393 includes an output end 312, 322, 382, 392 respectively. Each of the output ends 312, 322, 382, 392 provides a high voltage when the corresponding backlight 311, 321, 381, 391 works. Each of the output ends 312, 322, 382, 392 provides a low voltage when the corresponding backlight 311, 321, 381, 391 has an open circuit or a short circuit connecting to ground.

The PWM IC 350 includes a current sampling pin 351. The PWM IC 350 stops working if the current sampling pin 351 has a low voltage.

The first transistor 371 includes a source electrode “S”, a drain electrode “D”, and a gate electrode “G”. The source electrode “S” of the first transistor 371 is connected to ground. The drain electrode “D” of the first transistor 371 is connected to the current sampling pin 351 of the PWM IC 350. The gate electrode “G” of the first transistor 371 is connected to a power supply via a current limiting resistor 372. The power supply is provided by a power pin (not labeled) of the PWM IC 350, and is typically a five volt direct current power supply.

The first input circuit 330 includes a second transistor 334, a third transistor 336, two diodes 331, two resistors 332, and two capacitors 333. Each of the second and third transistors 334, 336 includes a source electrode “S”, a drain electrode “D”, and a gate electrode “G”. The drain electrode “D” of the second transistor 334 is connected to the gate electrode “G” of the first transistor 371. The source electrode “S” of the second transistor 334 is connected to drain electrode “D” of the third transistor 336. The source electrode “S” of the third transistor 336 is connected to ground. The gate electrode “G” of the second transistor 334 is connected to the negative terminal of one of the diodes 331, and is connected to ground respectively via one of the resistors 332 and via one of the capacitors 333. The gate electrode “G” of the third transistor 336 is connected to the negative terminal of the other diode 331, and is connected to ground respectively via the other resistor 332 and via the other capacitor 333. The positive terminals of the two diodes 331 are respectively connected to the output ends 382, 392 of the corresponding backlight inspecting circuits 383, 393.

The second input circuit 340 includes two input resistors 341, 342. The output end 312 of the backlight inspecting circuit 313 is connected to the current sampling pin 351 of the PWM IC 350 via the input resistor 341. The output end 322 of the backlight inspecting circuit 323 is connected to the current sampling pin 351 of the PWM IC 350 via the input resistor 342.

The diodes 331 can for example be SN4148 type diodes. A resistance of the current limiting resistor 372 is preferably 100 KΩ. A resistance of each of the input resistors 341, 342 is preferably 3.9 KΩ. Alternatively, the resistance of each of the input resistors 341, 342 can be 1.0MΩ. The PWM IC 350 can for example be an OZ9910G type PWM IC. The first transistor 371, the second transistor 334, and the third transistor 336 can be negative-channel metal oxide semiconductor (NMOS) type transistors or negative-positive-negative (NPN) type transistors.

Generally, operation of the backlight control circuit 300 is as follows. When the backlights 311, 321 of the backlight inspecting circuits 310, 320 work, the corresponding output ends 312, 322 of the backlight inspecting circuits 313, 323 each provide a high voltage to the current sampling pin 351 of the PWC IC 350 via the input resistors 341, 342 respectively. When the backlights 381, 391 of the backlight inspecting circuits 380, 390 work, the corresponding output ends 382, 392 of the backlight inspecting circuits 383, 393 each provide a high voltage to the gate electrodes “G” of the second and third transistors 334, 336 respectively via the corresponding diodes 331. Then the second and third transistors 334, 336 are switched to be in an activated state, and the gate electrode “G” of the first transistor 371 is connected to ground via the activated second and third transistors 334, 336. Thus the first transistor 371 is turned off, the current sampling pin 351 of the PWM IC 350 maintains the high voltage, and the PWM IC 350 continues working.

When the backlight 381 or the backlight 391 has an open circuit or a short circuit connecting to ground, the output end 382 or the output end 392 provides a low voltage to the gate electrode “G” of the second transistor 334 or the gate electrode “G” of the third transistor 336 via the corresponding diode 331. Then the second transistor 334 or the third transistor 336 is turned off, so that the gate electrode “G” of the first transistor 371 is charged to a high voltage by the power supply. Thus the first transistor 371 is switched to be in an activated state, so that the current sampling pin 351 of the PWM IC 350 is connected to ground via the activated first transistor 371. Then the current sampling pin 351 of the PWM IC 350 is discharged to a low voltage, and the PWM IC 350 stops working.

When the backlight 311 or the backlight 321 has an open circuit or a short circuit connecting to ground, the output end 312 or the output end 322 directly provides a low voltage to the current sampling pin 351 of the PWM IC 350 via the input resistor 341 or the input resistor 342. Thus, the PWM IC 350 stops working.

The backlight control circuit 300 needs only the three transistors 371, 334, 336 to carry out the function of protecting the backlights 311, 321, 381, 391. Therefore, the backlight control circuit 300 has low cost.

In alternative embodiments, when the number of load circuits increases, the circuit configuration of the first input circuit and the circuit configuration of the second input circuit can be adjusted according to the principles on which the backlight control circuits 200, 300 are configured. For example, the number of the load circuits can be n+m, where n, m are equal to each other, and n, m are each >=1. The first input circuit includes m second transistors, m diodes, m resistors, and m capacitors. The second input circuit includes n input resistors. The second transistors are connected in series with one another though the source electrode of one of the second transistors connecting with the drain electrode of an adjacent next one of the second transistors. This chain of second transistors is connected between the gate electrode of a first transistor and ground as follows. The drain electrode of a first one of the second transistors is connected to the gate electrode of the first transistor, and the source electrode of a last one of the second transistors is connected to ground. Further, the gate electrode of each of the second transistors is connected to ground respectively via one of the resistors and via one of the capacitors. The gate electrode of each of the second transistors is also connected to the negative terminal of one of the diodes. The positive terminal of each diode is connected to the output end of a respective one of the m load circuits. Each output end of each of the n load circuits is connected to the current sampling pin of the PWM IC via one of the input resistors.

It is to be understood, however, that even though numerous characteristics and advantages of preferred embodiments have been set out in the foregoing description, together with details of the structures and functions of the embodiments, the disclosure is illustrative only. Changes may be made in detail, especially in matters of shape, size, and arrangement of parts within the principles of present invention to the full extent indicated by the broad general meaning of the terms in which the appended claims are expressed.

What is claimed is:

1. A backlight control circuit comprising:
a first load circuit comprising a first backlight and a first backlight inspecting circuit connected in series, wherein the first backlight inspecting circuit includes a first output end;
a second load circuit comprising a second backlight and a second backlight inspecting circuit connected in series, wherein the second backlight inspecting circuit includes a second output end;
a pulse width modulation integrated circuit (PWM IC) comprising a current sampling pin;
a first transistor comprising a source electrode configured to be connected to ground, a drain electrode connected to the current sampling pin of the PWM IC, and a gate electrode configured to be connected to a power supply;
a first input circuit comprising:
a diode comprising a positive terminal connected to the second output end of the second backlight inspecting circuit, and a negative terminal;
a resistor;
a capacitor; and
a second transistor comprising a drain electrode connected to the gate electrode of the first transistor, a source electrode configured to be connected to ground, and a gate electrode configured to be connected to ground respectively via the resistor and via the capacitor, the gate electrode also being connected to the negative terminal of the diode; and
a second input circuit comprising an input resistor, the first output end of the first backlight inspecting circuit connected to the current sampling pin of the PWM IC via the input resistor.

2. The backlight control circuit as claimed in claim 1, further comprising:
a third load circuit comprising a third backlight and a third backlight inspecting circuit connected in series, wherein the third backlight inspecting circuit includes a third output end;
a fourth load circuit comprising a fourth backlight and a fourth backlight inspecting circuit connected in series, wherein the fourth backlight inspecting circuit includes a fourth output end;
a third input circuit comprising:
a diode comprising a positive terminal connected to the third output end of the third backlight inspecting circuit, and a negative terminal;
a resistor;
a capacitor; and
a third transistor comprising a drain electrode, a source electrode, and a gate electrode, the gate electrode connected to the negative terminal of the diode and configured to be connected to ground via the resistor and the capacitor respectively, the source electrode of the second transistor connected to ground via the drain electrode and the source electrode of the third transistor in that order; and
a fourth input circuit comprising an input resistor, the fourth output end of the fourth backlight inspecting circuit connected to the current sampling pin of the PWM IC via the input resistor.

3. The backlight control circuit as claimed in claim 2, wherein the third transistor is a negative-positive-negative (NPN) type transistor.

4. The backlight control circuit as claimed in claim 1, further comprising a current limiting resistor, wherein the gate electrode of the first transistor is configured to be connected to the power supply via the current limiting resistor.

5. The backlight control circuit as claimed in claim 4, wherein a resistance of the current limiting resistor is approximately equal to 100 KΩ.

6. The backlight control circuit as claimed in claim 1, wherein the power supply is a five volt direct current power supply.

7. The backlight control circuit as claimed in claim 1, wherein the first and the second transistors are negative-positive-negative (NPN) type transistors.

8. The backlight control circuit as claimed in claim 1, wherein a resistance of the input resistor of the second input circuit is approximately equal to 3.9 KΩ.

9. The backlight control circuit as claimed in claim 1, wherein a resistance of the input resistor of the second input circuit is approximately equal to 1.0MΩ.

10. A backlight control circuit comprising:
n+m load circuits, each of which comprises a first backlight and a first backlight inspecting circuit connected in series, each first backlight inspecting circuit comprising an output end, where n and m are equal to each other, and n and m are each >=1;
a pulse width modulation integrated circuit (PWM IC) comprising a current sampling pin;
a first transistor comprising a source electrode configured to be connected to ground, a drain electrode connected to the current sampling pin of the PWM IC, and a gate electrode configured to be connected to a power supply;
a first input circuit comprising:
m diodes, each of which comprises a positive terminal connected to the output end of a respective one of the m backlight inspecting circuits, and a negative terminal;
m resistors;
m capacitors; and
m second transistors each comprising a source electrode, a drain electrode, and a gate electrode, the m second transistors configured to be connected in series between the gate electrode of the first transistor and ground though the drain electrodes and the source electrodes of the m second transistors, the gate electrode of each of the second transistors being configured to be connected to ground via a respective one of the m resistors and via a respective one of the m capacitors, the gate electrode of each of the second transistors also being connected to a negative terminal of a respective one of the m diodes; and
a second input circuit comprising n input resistors, the output end of each of the n backlight inspecting circuits being connected to the current sampling pin of the PWM IC via a respective one of the n input resistors.

11. The backlight control circuit as claimed in claim 10, wherein n and m are each equal to 1.

12. The backlight control circuit as claimed in claim 10, wherein n and m are each equal to 2.

13. The backlight control circuit as claimed in claim 10, wherein the first transistor is a negative-positive-negative (NPN) type transistor.

14. The backlight control circuit as claimed in claim 10, further comprising a current limiting resistor, the gate electrode of the first transistor configured to be connected to the power supply via the current limiting resistor.

15. The backlight control circuit as claimed in claim 14, wherein a resistance of the current limiting resistor is approximately equal to 100 KΩ.

16. The backlight control circuit as claimed in claim 10, wherein the power supply is a five volt direct current power supply.

17. The backlight control circuit as claimed in claim 10, wherein the first and the second transistors are negative-positive-negative (NPN) type transistors.

18. The backlight control circuit as claimed in claim 10, wherein a resistance of each of the n input resistors of the second input circuit is approximately equal to 3.9 KΩ.

19. The backlight control circuit as claimed in claim 10, wherein a resistance of each of the n input resistors of the second input circuit is approximately equal to 1.0MΩ.
